(19) United States
(12) Patent Application Publication
(10) Pub. No.: US 2010/0215796 A1
(43) Pub. Date: Aug. 26, 2010

(54) MOVING PLATEN AND INJECTION MOLDING MACHINE UTILIZING THE SAME

(75) Inventors: YU-TA CHEN, Tu-Cheng (TW); WEN-REY WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/485,853

(22) Filed: Jun. 16, 2009

(30) Foreign Application Priority Data
Feb. 25, 2009 (CN) 200910300547.2

(51) Int. Cl. B29C 45/56

(52) U.S. Cl. 425/574; 425/595

(57) ABSTRACT

A moving platen includes a first plate to be mounted to a moving die, a second plate mounted to the first plate, and a sac element sandwiched between the first plate and the second plate.

### BACKGROUND

1. Technical Field

The disclosure relates to molding, and particularly, to a moving platen and an injection molding machine utilizing the moving platen.

2. Description of Related Art

In an injection molding machine, a clamping unit is used for mold-closing and mold-opening functions. Double-toggle clamping unit is the most popular clamping unit now. However, when the double-toggle clamping unit performs the mold-closing function, the mold-closing force provided by the double-toggle clamping unit acts on opposite ends of a moving platen of the injection molding machine which easily causes the moving platen to bend, therefore, causes molded products to be defective.

### BRIEF DESCRIPTION OF THE DRAWINGS

FIG. 1 is an exploded, isometric view of an embodiment of an injection molding machine.

FIG. 2 is an assembled view of the injection molding machine of FIG. 1.

FIG. 3 is a cross-sectional view of FIG. 2, taken along the line III-III.

### DETAILED DESCRIPTION

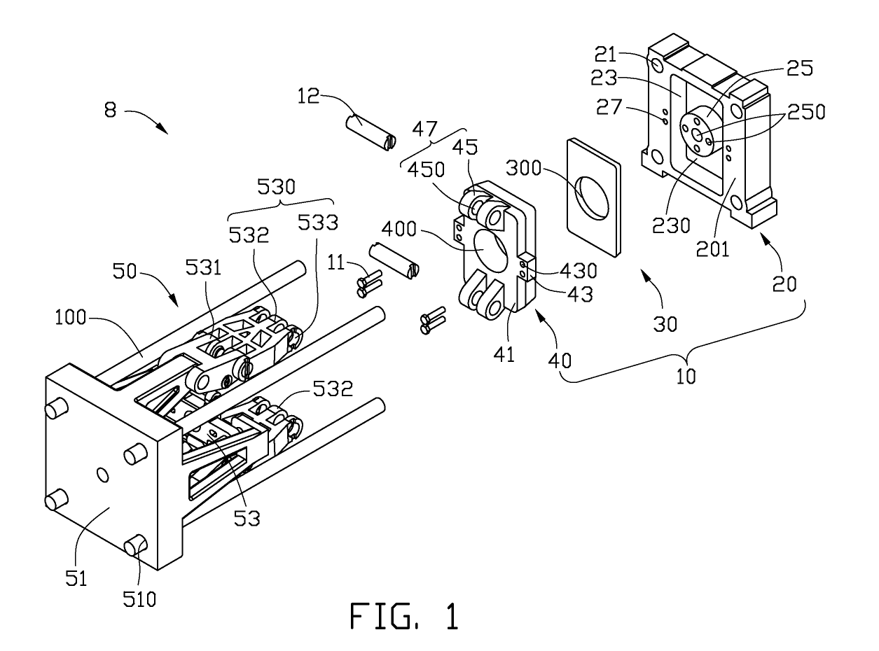

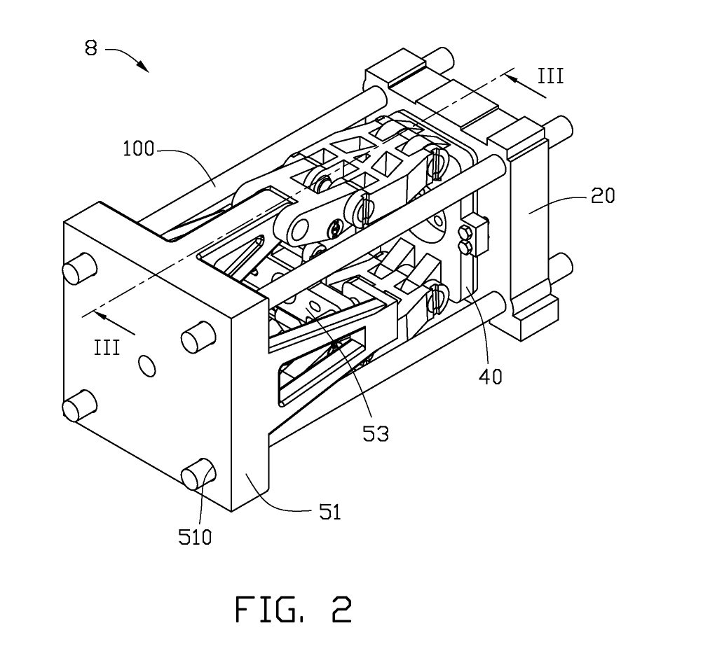

Referring to FIGS. 1 to 3, an embodiment of an injection molding machine 8 includes a moving platen 10, and a clamping unit 50.

The clamping unit 50 is a double-toggle clamping unit and includes a rear platen 51, and a toggle mechanism 53 fixed to a side of the rear platen 51.

The rear platen 51 is rectangular-shaped and defines four holes 510 in four corners of the rear platen 51.

The toggle mechanism 53 includes two toggle linkages 531. Each toggle linkage 531 includes a first pivot portion 530 at a distal end opposite to the rear platen 51 of the toggle linkage 531. Each first pivot portion 530 includes three spaced first projecting pieces 532 each defining a first pivot hole 533. The first pivot holes 533 of the first projecting pieces 532 of each first pivot portion 530 are coaxial.

The moving platen 10 includes a first plate 20, a second plate 40, and an sac element 30 sandwiched between the first plate 20 and the second plate 40.

The first plate 20 is rectangular-shaped. Four guiding holes 21 are defined in four corners of the first plate 20. A receiving groove 23 is defined in a first side 201 of the first plate 20, facing the rear platen 51. A columniform projection 25 extends from a bottom wall 230 of the receiving groove 23. A plurality of through holes 250 are axially defined in the projection 25 and extends through a second side 202 opposite to the first side 201 of the first plate 20. The first side 201 defines two mounting holes 27 in each of opposite sides of the receiving groove 23.

The sac element 30 has a shape matching the receiving groove 23 of the first plate 20. A trough hole 300 is defined in a center of the sac element 30. The sac element 30 includes a flexible shell 301, with liquid 302 filled in the shell 301. In other embodiments, gas may be filled in the shell 301 instead of the liquid 302.

The second plate 40 includes a main body 41 having a shape matching the receiving groove 23 of the first plate 20. A trough hole 400 is defined in a center of the main body 41. Two second pivot portions 47 corresponding to the first pivot portions 530 of the toggle mechanism 53 extend perpendicularly from opposite ends of the main body 41 towards the rear platen 51. Each second pivot portion 47 includes two spaced second projecting pieces 45 each defining a second pivot hole 450. The pivot holes 533 of the second projecting pieces 45 of each second pivot portion 47 are coaxial. Two mounting portions 43 extend from opposite sides of the main body 41. Each mounting portion 43 defines two mounting holes 430 corresponding to the mounting holes 27 of the first plate 20.

In assembly, the sac element 30 is received in the receiving groove 23 of the first plate 20, with the projection 25 of the first plate 20 extending through the trough hole 300 of the sac element 30. A part of the main body 41 of the second plate 40 is received in the receiving groove 23 to press the sac element 30, with the projection 25 of the first plate 20 extending through the trough hole 400 of the second plate 40. Four fixing elements 11 are used to extend through the corresponding mounting holes 430 of the second plate 40 to engage in the corresponding mounting holes 27 of the first plate 20, to mount the second plate 40 to the first plate 20. The rear platen 51 is mounted to four tie bars 100 via the holes 510. The first plate 20 is slidably mounted to the four tie bars 100 via the guiding holes 21. Each second projecting piece 45 of each second pivot portion 47 is inserted between two adjacent first projecting pieces 532 of a corresponding first pivot portion 530, with the corresponding first and second pivot holes 533 and 450 being in alignment. Two pivot pins 12 are inserted into the first and second pivot holes 533 and 450 to pivotably mount the second pivot portions 47 to the corresponding first pivot portions 530.

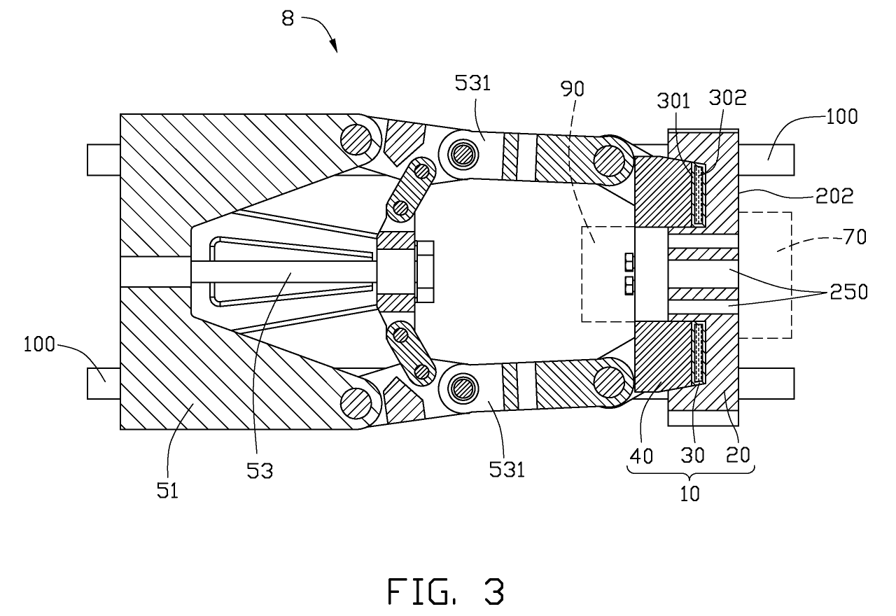

In use, the second side 202 of the first plate 20 is mounted to a moving die 70 (see FIG. 3) of a mold. An ejector 90 is mounted to the second plate 40, between the second pivot portions 47. The ejector 90 communicates with the mold via the through holes 250 of the first plate 20, to eject products molded by the mold. In closing the mold, mold-closing force provided by the clamping unit 50 is transmitted to the second plate 40 via the toggle linkages 531, and then transmitted to the first plate 20 via the sac element 30. According to the Pascal's Principle, pressure applied on the liquid 302 is transmitted undiminished to every part of the shell 301 of the sac element 30, thereby the sac element 30 equably transmitting the mold-closing force to the first plate 20. Therefore, the sac element 30 can prevent the first plate 20 from being deformed under the mold-closing force, so that quality of the molded products can be improved.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A moving platen comprising:
a first plate to be mounted to a moving die;
a second plate mounted to the first plate; and
a sac element sandwiched between the first plate and the second plate.

2. The moving platen of claim 1, wherein the sac element comprises a flexible shell, with liquid filled in the shell.

3. The moving platen of claim 2, wherein a receiving groove is defined in a first side of the first plate, the sac element is received in the receiving groove, a shape of the sac element matches a shape of the receiving groove.

4. The moving platen of claim 3, wherein a projection extends from a bottom wall of the receiving groove, a plurality of through holes are defined in the projection and extend through a second side opposite to the first side of the first plate, the sac element defines a through hole for the projection to pass therethrough.

5. The moving platen of claim 4, wherein the second plate comprises a main body, the main body is partly received in the receiving groove to press the sac element.

6. The moving platen of claim 5, wherein a through hole is defined in the second plate to receive the projection.

7. The moving platen of claim 5, wherein two mounting portions extend from opposite sides of the main body of the second plate, each of the mounting portions defines a plurality of first mounting holes, a plurality of second mounting holes are defined in the first plate corresponding to the plurality of first mounting holes, a plurality of fixing elements extend through the first mounting holes and engages in the corresponding second mounting holes respectively to mount the second plate to the first plate.

8. An injection molding machine comprising:
a moving platen comprising
a first plate to be mounted to a moving die;
a second plate mounted to the first plate; and
a sac element sandwiched between the first plate and the second plate; and
a clamping unit connected to the second plate to provide mold-closing force to the moving platen.

9. The injection molding machine of claim 8, wherein the clamping unit is a double-toggle clamping unit.

10. The injection molding machine of claim 9, wherein the clamping unit comprises a rear platen and a toggle mechanism fixed to the rear platen, the toggle mechanism comprises two toggle linkages pivotably connected to the second plate.

11. The injection molding machine of claim 10, wherein a first pivot portion extends from each of the toggle linkages and comprises three spaced first projecting pieces each defining a first pivot hole, a second pivot portion extends from the second plate corresponding to each first pivot portion and comprises two spaced second projecting pieces each defining a second pivot hole, each second projecting piece of each second pivot portion is inserted between two adjacent first projecting pieces of the corresponding first pivot portion, a pivot pin is inserted into the first pivot holes of each first pivot portion and the second pivot holes of the corresponding second pivot portion.

12. The injection molding machine of claim 8, wherein the sac element comprises a flexible shell, with liquid filled in the shell.

13. The injection molding machine of claim 12, wherein a receiving groove is defined in a first side of the first plate, the sac element is received in the receiving groove, a shape of the sac element matches a shape of the receiving groove.

14. The injection molding machine of claim 13, wherein a projection extends from a bottom wall of the receiving groove, a plurality of through holes are defined in the projection and extends through a second side opposite to the first side of the first plate, the sac element defines a through hole for the projection to pass therethrough.

15. The injection molding machine of claim 14, wherein the second plate comprises a main body, the main body is partly received in the receiving groove to press the sac element.

16. The injection molding machine of claim 15, wherein a through hole is defined in the second plate to receive the projection.

17. The injection molding machine of claim 15, wherein two mounting portions extend from opposite sides of the main body of the second plate, each of the two mounting portions defines a plurality of first mounting holes, a plurality of second mounting holes are defined in the first plate corresponding to the plurality of first mounting holes, a plurality of fixing elements extend through the first mounting holes and engages in the corresponding second mounting holes respectively to mount the second plate to the first plate.
